(19) United States
(12) Patent Application Publication
(10) Pub. No.: US 2007/0026754 A1
(43) Pub. Date: Feb. 1, 2007

(54) Scouring material

(76) Inventors: Carmen Martin Rivera, Madrid (ES); Estrella Cabrero Gomez, Madrid (ES); Guy M. Pollaud, St. Germain en Laye (FR)

Correspondence Address: 3M INNOVATIVE PROPERTIES COMPANY, PO BOX 33427, ST. PAUL, MN, 55133-3427, US

(21) Appl. No.: 10/554,213

(22) PCT Filed: Apr. 2, 2004
(86) PCT No.: PCT/US04/10198

§ 371 Date: Jun. 20, 2006

(30) Foreign Application Priority Data
Apr. 25, 2003 (GB) 0309329.1

(51) Int. Cl. D04H 1/46; D04H 3/10; B32B 5/16

(52) U.S. Cl. 442/402; 442/417; 442/408; 156/283

(57) ABSTRACT

A scouring material comprises a three-dimensional non-woven web of entangled fibres bonded to one another at their mutual contact points by a pre-bond resin and a plurality of abrasive particles are adhered to the fibres of the bonded web by a make-coat resin. A majority by weight of the fibres comprise natural fibres and the bonded web has a maximum density of 50 kg/m³. A method of making a scouring material comprises the steps of: 1) forming a three-dimensional nonwoven web of natural fibres contacted with dry particulate material that includes fusible binder particles, 2) exposing the web to conditions that cause the binder particles to form a flowable liquid binder, and then solidifying the liquid binder to form bonds between the fibres of the web and thereby provide a pre-bonded web and 3) applying abrasive particles to the pre-bonded web and bonding the abrasive particles to the fibres of the pre-bonded web by at least a make-coat resin to provide the scouring material.

### BACKGROUND

Scouring materials for domestic use are produced in many forms, including nonwoven webs (for example, the low density nonwoven abrasive webs described in U.S. Pat. No. 2,958, 593). Following manufacture, a web of scouring material may be cut into individual pieces of a size suitable for hand use (for example, the individual rectangular pads described in U.S. Pat. No. 2,958,593) or it may be left to the end user to divide the web into pieces of a convenient size when required (as described, for example, in WO 00/006341 and U.S. Pat. No. 5, 712,210).

Other domestic scouring pads formed using nonwoven web materials are known, for example the pads described in U.S. Pat. Nos. 2,327,199, 2,375,585 and 3,175,331. Nonwoven hand pads for more general abrasive applications are also known and include, for example, the hand pads available under the trademark “Scotch-Brite” from 3M Company of St. Paul, Minn., USA.

Preferred nonwoven fibrous scouring materials are low density, open materials having a comparatively high void volume. Scouring materials of that type exhibit an effective cleaning action (because the voids retain material removed from a surface that is being cleaned) but are themselves easily cleaned simply by rinsing in water or some other cleansing liquid so that they can be re-used. Despite that, many scouring materials employed in the domestic environment are intended for limited re-use only, following which they are discarded. From a hygiene standpoint, discarding such products before they become contaminated is to be recommended since they are frequently used for cleaning kitchen work surfaces as well as cooking and eating utensils. However, as consumers become increasingly concerned with environmental issues, they are increasingly reluctant to use disposable products unless they know that they can be recycled or will degrade quickly without producing harmful by-products. For this reason, there is growing interest in the use of products based on natural materials for domestic cleaning.

Scouring materials formed solely from natural vegetable fibres are known and include, for example, traditional scourers formed from the fibrous parts of gourds or palm leaves. Such scouring materials will degrade in an environmentally-acceptable manner but suffer from the disadvantage that, when made in the traditional manner, they cannot be mass produced to a uniform standard. Moreover, natural vegetable fibres have little or no resilience (unlike the crimped synthetic fibres that are used to manufacture nonwoven abrasive/scouring materials) so that, even if they are processed into a more uniform nonwoven web, it is difficult to incorporate abrasive mineral into the web without crushing the fibres and, as a result, compacting the web to an undesirable extent. Consequently, domestic scouring materials formed from natural fibres have tended to be less attractive to the consumer than those that are formed from synthetic fibres.

### SUMMARY

The present invention provides a scouring material comprising a three-dimensional non-woven web of entangled fibres bonded to one another at their mutual contact points by a pre-bond resin, wherein a majority by weight of the fibres comprise natural fibres, and the bonded web has a maximum density of 50 kg/m³ (preferably 30 kg/m³) A plurality of abrasive particles are adhered to the fibres of the bonded web by a make-coat resin.

The present invention also provides a method of making a scouring material comprising the steps of: 1) forming a three-dimensional nonwoven web of natural fibres contacted with dry particulate material that includes fusible binder particles, 2) exposing the web to conditions that cause the binder particles to form a flowable liquid binder, and then solidifying the liquid binder to form bonds between the fibres of the web and thereby provide a pre-bonded web and 3) applying abrasive particles to the pre-bonded web and bonding the abrasive particles to the fibres of the pre-bonded web by at least a make-coat resin to provide the scouring material.

### BRIEF DESCRIPTION OF THE DRAWINGS

By way of example only, scouring materials in accordance with the invention and methods for their manufacture will now be described with reference to the accompanying drawings, in which:

FIG. 1 is a view of a scouring pad in accordance with the invention;

FIG. 2 illustrates, diagrammatically and on an enlarged scale, the structure of a scouring pad in accordance with the invention;

FIG. 3 is a schematic illustration of a method of making the scouring material of FIG. 1; and

FIG. 4 illustrates a modification of part of the method of FIG. 3.

### DETAILED DESCRIPTION

The present invention is directed to the problem of providing a scouring material that is capable of providing an effective cleaning action in the domestic environment and, at the end of its effective life, can be discarded in the knowledge that it will degrade in an environmentally-friendly manner.

The present invention provides a scouring material comprising an open, lofty, three-dimensional not woven web of entangled fibres that are bonded to one another at their mutual contact points by a pre bond resin, wherein a majority by weight of the fibres comprise natural fibres A plurality of abrasive particles are adhered to the fibres of the bonded web by a make-coat resin.

The terms “open” and “lofty” indicate that the bonded web is of comparatively low density, having a network of many, relatively large, intercommunicated voids that comprise the greater amount (more than 50%, preferably substantially more than 50%) of the volume occupied by the web. In the context of the present invention, the terms indicate that the bonded web has a density no greater than 50 kg/m³, preferably no greater than 30 kg/m³. Preferably, the bonded web has a minimum thickness of 5 mm.

It has been found that a scouring material in accordance with the invention is capable of providing an effective scouring action despite the fact that the natural fibres from which it is mainly composed are traditionally associated with non-woven materials having a low void-volume and/or a low abrasive action. After use, the scouring material can be discarded in the knowledge that the fibres (which are the major component of the material) will degrade in an environmentally acceptable manner.

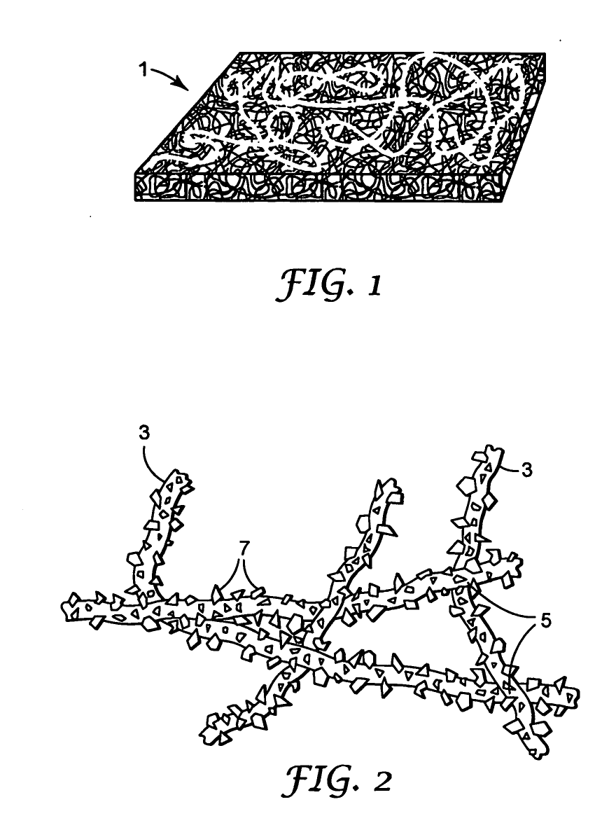

Referring to the Figures, the generally rectangular scouring pad 1 shown in FIG. 1 is intended for hand use and comprises a three-dimensional non-woven web of entangled fibres 3 (see FIG. 2) that are bonded to one another at their mutual contact points. The bonded web preferably has a minimum thickness of 5 mm and a maximum density of 50 kg/m³ (more preferably, 30 kg/m³).

The fibres 3 of the pad 1 are bonded to one another at their mutual contact points 5 by a pre-bond resin as described below, and the pad additionally contains abrasive particles 7 that are adhered to the fibres by a make-coat resin, as also described below. The fibres 3 comprise at least 80% by weight of natural fibres, preferably vegetable fibres such as coco, sisal, and hemp fibres. Other natural fibres that could be used include those of cotton, jute, flax and wool. When synthetic fibres are present, they can be made of any suitable material including polyester (e.g., polyethylene terephthalate), polyamide (e.g., hexamethylene adipamide, polycaprolactum and aramids), polypropylene, acrylic (formed from a polymer of acrylonitrile), rayon, cellulose acetate, polyvinylidene chloride-vinyl chloride copolymers, and vinyl chloride-acrylonitrile copolymers, as well as carbon fibres and glass fibres. The fibers used may be virgin fibers or waste fibers reclaimed from garment cuttings, carpet manufacturing, fiber manufacturing, or textile processing, and so forth.

The pre-bond resin by which the fibres 3 are bonded to one another at their mutual contact points 5 is selected to provide the scouring material with good strength and water/heat resistance. The binder rhaterials may be selected from among certain thermosetting resins, including formaldehyde-containing resins, such as phenol formaldehyde, novolac phenolics and especially those with added crosslinking agent (e.g., hexamethylenetetramine), phenoplasts, and aminoplasts; unsaturated polyester resins; vinyl ester resins; alkyd resins, allyl resins; furan resins; epoxies; polyurethanes; and polyimides. The binder materials may also be selected from among certain thermoplastic resins, including polyolefin resins such as polyethylene and polypropylene; polyester and copolyester resins; vinyl resins such as poly(vinyl chloride) and vinyl chloride-vinyl acetate copolymers; polyvinyl butyral; cellulose acetate; acrylic resins including polyacrylic and acrylic copolymers such as acrylonitrile-styrene copolymers; and polyamides (e.g., hexamethylene adipamide, polycaprolactum), and copolyamides. Preferably, the pre-bond resin 5 is an epoxy, or a polyurethane, or a co-polyamide resin.

Mixtures of the above thermosetting and thermoplastic resins may also be used.

The abrasive particles 7 can be of any type known to be suitable for use in scouring pads, taking into account the nature of the surfaces to be cleaned and the abrasive action desired. Included among the suitable abrasive materials are particles of inorganic materials, for example aluminum oxide including ceramic aluminum oxide, heat-treated aluminum oxide and white-fused aluminum oxide; as well as silicon carbide, tungsten carbide, alumina zirconia, diamond, ceria, cubic boron nitride, silicon nitride, garnet, and combinations of the foregoing. It is contemplated that abrasive agglomerates may also be used in the invention such as those described in U.S. Pat. Nos. 4,652,275 and 4,799,939. Suitable abrasive particles also include softer, less aggressive materials such as thermosetting or thermoplastic polymer particles as well as crushed natural products such as crushed nut shells, for example. Suitable polymeric materials for the abrasive particles include polyamide, polyester, poly(vinyl chloride), poly(methacrylic) acid, polymethylmethacrylate, polycarbonate, polystyrene and melamine-formaldehyde condensates. The abrasive particles preferably will have a particle size small enough to allow penetration of the particles into the interstices of the nonwoven fibrous web 1.

The make-coat resin can be any resin known to be suitable for use as a make-coat in scouring materials, including water-based resins. Preferred binders include phenolic resins (more especially, for example, for harder-wearing scouring materials) and latex resins (more especially, for example, for scouring materials for non-scratch bathroom cleaning).

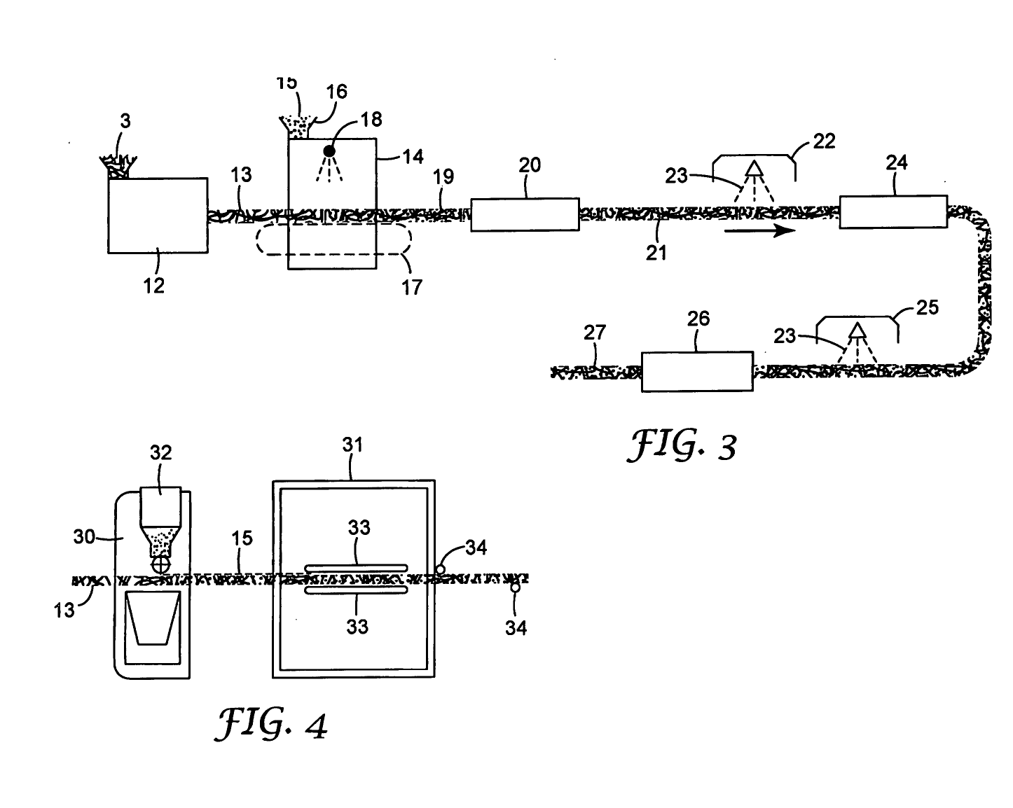

A first process for making the scouring pad of FIG. 1 is illustrated in FIG. 3, and will now be described. A process of this type is also described in our co-pending patent application of even date (GB application no. 0309393.7).

If the selected fibres 3 are provided in bales, the latter are first opened. The fibres are then supplied to web-forming equipment 12 in which they are formed into a dry-laid, open, lofty, three-dimensional nonwoven web 13. A preferred type of nonwoven web is an air-laid web as described in U.S. Pat. No. 2,958,593, in which case the web-forming equipment 12 may be a commercially-available “Rando-Webber” device, such as obtained from Rando Machine Co., Macedon, N.Y., and the lengths of the fibres 3 are preferably within the range 3-30 cms. The web 13 is preferably formed with a minimum thickness of 5 mm and a maximum density of 50 kg/m³ (more preferably, 30 kg/m³).

The nonwoven web 13 is then fed into a powder coating booth 14 where it is contacted by a particulate pre-bond resin 15 supplied from a fluidizing hopper 16. Optional dry particle additives (such as pigment powder and flow aids) that are to be applied to the nonwoven web 13 at this stage may be mixed with the resin particles 15 in the hopper 16. The nonwoven web 13 is conveyed through the powder-coating booth 14 on a grounded, electrically-conductive, open mesh conveyor 17 and the particulate resin 15 is directed at it from an electrostatic powder spray gun 18, of a type known for use in powder coating applications, which is located above the web. The resin particles 5 will penetrate the whole thickness of the web 13, under the combined effects of electrostatic attraction, gravity and the flow of atomizing air from the spray gun 18. Any resin powder that passes through the web 13 and the conveyor belt 17 is collected at the bottom of the booth 14 and can be re-used.

If desired, the web 13 can now be turned over and conveyed for a second time through the powder coating booth 14 to increase the amount of resin powder 15 that is loaded into the web at this stage.

The pre-bond resin 15 in the web will subsequently be activated, as described below, to form bonds between the fibres of the web and thus provide a pre-bonded web to which abrasive particles are subsequently applied. The resin particles 15 should therefore be selected having regard to the nature of the web fibres and the subsequent processing steps to which the pre-bonded web will be subjected, and having regard also to the desired properties of the scouring material that is to be produced.

Particulate resins suitable for use in bonding nonwoven webs are known, and include thermosetting and thermoplastic powders that are activated by heat, as well as powders that are activated other ways (for example, by moisture). Particulate materials suitable for bonding nonwoven webs for various purposes are described, for example, in U.S. Pat. Nos. 4,053,674, 4,457,793, 5,668,216, 5,886,121, 5,804,005, 5,9767,244, 6,039,821, 6,296,795, 6,458,299, and 6,472,462. The particulate binder materials suitable for use in the manufacture of scouring materials are those that will provide the scouring materials with good strength and water/heat resistance and are capable of being activated without damaging the web fibres. Preferred binder materials, as described above, are epoxy, polyurethane and co-polyamide particulate resins.

The resin particles 15 should be of a size suitable for use in the spray gun 18, and should be small enough to ensure that they can penetrate into the interstitial spaces between the fibres of the web 13. Preferably, they have a particle size no greater than 200 micrometers. To minimize wastage, the amount of resin particles 15 applied to the web 13 in the powder coating booth 14 should be adjusted to the minimum amount consistent with providing adequate bonding of the web.

The powder-containing nonwoven web 19 from the booth 14 is then exposed to conditions that will liquefy the resin particles to a flowable condition, following which the resin is cured to form bonds between the web fibres. For example, if the resin is a heat-activated thermosetting material (for example, a powdered epoxy resin), the web 19 is passed through the oven 20 in which it is heated first to liquefy the resin so that it will coat the web fibres, and then to cure the resin so that it will bond the fibres together at their mutual contact points. If, as another example, the resin is a thermoplastics material the web 19 is passed through the oven 20 simply to liquefy the resin so that it will coat the web fibres following which the web is allowed to cool so that the resin solidifies and binds the web fibres together at their contact points. In each case, the resin should be selected to ensure that the web will not be damaged by the temperatures to which it is exposed at this stage.

When the pre-bonded web 21 has cooled, it is passed through a first spray booth 22 in which one surface of the web is sprayed with a slurry 23 of the abrasive particles 7 mixed with a liquid make-coat resin which is subsequently cured by passing the web through an oven 24. The web then passes through a second spray booth 25 in which the other surface of the web is sprayed with the same abrasive-resin slurry which is then cured in a second oven 26. Preferred abrasive particles are corundum and poly(vinyl chloride) particles and preferred resins are phenolic and latex resins, although other abrasive materials and make coat resins mentioned above could be used. Additives such as fillers and pigments may also be included used in the abrasive-resin slurry, if desired.

In an alternative to the arrangement just described, the second spray booth 25 and the second oven 26 are omitted and, instead, the web 21 is turned over when it has left the oven 24 and is conveyed again through the spray booth 22 so that the other side of the web can be sprayed with the slurry 23. The web is then passed for a second time through the oven 24.

In either case, the resulting nonwoven scouring web can then be converted (following storage, if required) into scouring pads 1 as shown in FIG. 1.

Various other modifications can be made to the process described above and illustrated in FIG. 3. For example, the web-forming equipment 12 could be one that produces a dry-laid web by carding and cross-lapping, rather than by air-laying, and the powder-coating booth 14 could be replaced by other equipment known to be suitable for achieving an even distribution of powder resin throughout the web (for example, equipment employing a metering roll (e.g., a knurled roll powder applicator), powder spraying or sifting, or a fluidized bed, or the like may be successfully employed).

It is also possible to modify the manner in which the abrasive particles 7 are applied to the pre-bonded web 21. For example, instead of mixing the abrasive particles with a liquid binder composition to form a slurry, the liquid binder composition may be applied alone to the pre-bonded web (for example, by spraying or by roll-coating) following which the abrasive particles can be drop coated, sprinkled, sprayed, or the like, in a dry condition upon a surface of the web, for example by conveying the web beneath an abrasive particle dispenser. The binder composition is then cured to bind the abrasive particles to the fibres of the web. As a further alternative, the abrasive particles may be blended with a powdered resin binder, the blend then being applied in dry form to the pre-bonded nonwoven web.

As a further modification, an additional resin layer may be applied to the web after the abrasive particles 7 have been attached. This optional resin layer (also known as a size coat) will serve to consolidate the nonwoven scouring material and increase its wear resistance.

In another modified version of the method illustrated in FIG. 3, the particulate pre-bond resin 15 is mixed with the web fibres 1 prior to the formation of the nonwoven web in the web-forming equipment 12. In that case, the powder-coating booth 14 is omitted. In yet another modified version, the powder-coating booth 14 is replaced by the equipment illustrated in FIG. 4, comprising a powder scattering unit 30 and a powder impregnation unit 31. In that case, the web 13 from the web-forming equipment 12 passes into the unit 30, where the particulate pre-bond resin 15 (together with any optional dry particle additives) is distributed evenly from a dispenser 32 over the upper surface of the web. Any resin that happens to pass through the web is collected at the bottom of the unit 30 and can be re-used. The web then passes into the impregnation unit 31, where it passes between two electrode plates 33 across which an alternating voltage is applied: the effect of this is to distribute the resin powder 15 throughout the thickness of the web, following which the web passes to the oven 20 as in FIG. 1. Brushes 34, contacting the upper and lower surfaces of the web are located downstream of the impregnation unit 31 to remove any excess resin powder, which can be collected and re-used.

A method of the type illustrated in FIG. 4 is described in EP-A-0 914 916, while a further alternative method of contacting a fibrous web with a powder is described in EP-A-0 025 543.

The use of a particulate pre-bond resin 15 as described above enables an open, low-density, bonded nonwoven web 21 to be produced despite the fact that the web is constructed from fibres that are much less resilient than the crimped synthetic fibres that are normally used to form nonwoven fibrous webs for scouring materials and abrasive materials generally. The particulate resin 15 can be distributed in the unbonded web 13 without any compressive force being applied to the web. A compressive force on the un-bonded web 13, such as would occur if the resin were applied to the web in liquid form by roll coating or even by spraying, would result in the web being compacted and make it less effective, or even ineffective, for use as a basis for a nonwoven scouring material. Once the fibres have been bonded by the particulate resin 15, however, the web 21 is able to withstand the compressive forces that might arise during the application of the abrasive particles 7 and the make-coat resin.

Methods of producing scouring materials in accordance with the invention are described in greater detail in the following non-limiting examples. All parts and percentages are by weight unless indicated otherwise.

### EXAMPLES

The examples used the following materials, equipment and test methods.

Materials

Epoxy resin powder: “Beckrypox AF4” low temperature cure black thermoset powder (mean particle size 35 microns) from Dupont of Montbrison, France. Copolyamide resin powder: “Vestamelt 350 P1” thermoplastic powder 0-80 microns from Degussa of Marl, Germany.

Powder flow aid: “Aerosil 200” hydrophilic fumed silica powder from Degussa of Marl, Germany.

Sisal fibre: cut fibre from Caruso of Ebersdorf, Germany.

Coco fibre: cut fibre from Caruso of Ebersdorf, Germany.

Poly(vinyl chloride) particles: “Etinox 631” from Aiscondel, Spain

Corundum particles: very fine grade (average particle size approximately 50 microns) brown fused aluminium oxide from Pechiney, France.

Latex resin: “Styrofan ED609” from BASF, Spain.

Cross-linking agents: (i) Cymel 303 and (ii) Cymel 307 from Dyno Cytec, Norway.

Phenolic resin: “7983SW” from Bakelite AG of Iserlohn-Letmathe, Germany.

Equipment

Fiber opener: available from Laroche of Cours La Ville, France.

“Rando Webber”: an air-lay nonwoven web forming machine available from Rando Machine Co. of Macedon, N.Y., USA.

Web humidifier: a water spray head of a type used for room humidification, available from Hydrofog of Chanteloup les Vignes, France.

Powder coating equipment: “Versaspray II” electrostatic spray gun(s) from Nordson of Westlake, Ohio, USA, installed in a powder coating booth (also available from Nordson) and directed downwards towards a 30 cm wide horizontal metallic open mesh conveyor belt, which was electrically-grounded. The/each gun was fitted with a 2.5 mm flat spray nozzle. The powder coating booth was provided with a fluidizing hopper to contain powder (the hopper being fitted with a venturi pump to supply the powder to the gun(s)); a recovery drum to collect waste powder at the bottom of the booth; and an air control unit for regulating the supply of fluidizing air to the hopper, and of flow and atomizing air to the pump and gun(s). The hopper, pump and recovery drum are all available from Nordson. The powder booth incorporated features that enabled the safe handling of fine powders (including air extraction through cartridge and HEPA filters, and a fire detection system).

Infra-red oven: a “Curemaster Super” oven with three 1 kW short-wave infra-red heaters, available from Trisk of Sunderland, Tyne and Wear, UK.

Through-air ovens: a gas oven (4 meters long) and an electric oven (2 meters long), both available from Cavitec of Munchwilen, Switzerland.

Abrasive spray equipment: a spray booth equipped with one reciprocating spray gun, available from Charvot of Grenoble, France; and a spray booth equipped with four guns, available as Model 21 from Binks of Illinois, USA.

### Example 1

A 30 cm wide air-laid nonwoven web weighing 190 g/m² was formed from the sisal fibres on the “Rando Webber” machine at a rate of 2 m/min. The fibre bales had previously been pre-opened using the Laroche fibre opener. The web was conveyed in line through the powder coating booth on the open mesh conveyor belt, where copolyamide resin powder (blended with 0.5% by weight of flow aid) was directed at the web by two “Versapray II” spray guns, arranged one behind the other, that were fixed 30 cm above the web and inclined on opposite sides of the vertical at an angle in the range of 20°-30°. The resin powder was supplied to the guns from the hopper, in which it was fluidized until gently bubbling using air at a pressure of 1.5 bar. The air pressure settings for the gun were 2 bar for the flow air and 1 bar for the atomizing air, and the maximum voltage (100 kV) was applied. Resin powder was deposited in the web at a weight of about 60 g/m² and any resin powder that passed through the web was collected in the recovery drum, positioned underneath the open mesh conveyor belt. The powdered web was then heated in line, first in the infra-red oven at a temperature in the range of 150-160° C. with the heaters positioned 3 cm above the web to pre-set the resin powder and then in the electric oven at a temperature of 160° C. using a low-speed setting for the recirculating air. The total residence time in the oven was 1 min.

The web was then turned over and conveyed again through the powder coating booth and the ovens with the other surface of the web uppermost.

Poly(vinyl chloride) particles were then applied to the bonded web in the following manner. An abrasive-resin slurry was prepared by mixing together thoroughly the particles (25%) and the latex resin (68.5%) with the cross-linking agents (1.2% of (i) and 5.3% of (ii)). The slurry was then transferred to the supply tank of the spray booth having a single spray gun. The bonded web was passed through the spray booth at a speed of 2 m/min, and sprayed on one side with the slurry from the gun which was reciprocated across the web to ensure even coverage of the web with the slurry at a coating weight of about 300 g/m². The web was then passed through the gas oven in which it was heated at 180° C. for 2 min. to cure the latex resin. The web was then turned over and conveyed again through the spray booth so that it was sprayed with slurry on the other side in the same manner. It was then again passed through the gas oven.

The resulting nonwoven scouring web contained 150 g/m² of the poly(vinyl chloride) particles and was cut into pads having dimensions of about 75×90 mm.

### Example 2

Example 1 was repeated, with the following modifications:

The nonwoven web weighed 150-170 g/m² and was formed from the coco fibres on the “Rando Webber” machine at a slower rate (1 m/min) to enable the curing time for the resin powder to be increased (see later). Before entering the powder coater, the web was humidified to increase its conductivity and, thereby, its uptake of resin powder. The web was humidified using the water spray head which was supplied with water at a pressure of 1 bar and atomizing air at a pressure of 2.5 bar. The powder coater used a single “Versapray II” spray gun to direct the epoxy resin powder at the web from a distance of 30 cm. The resin powder was fluidized in the hopper of the powder coater using air at a pressure of 1.8 bar. The air pressure settings for the guns were 1 bar for the flow air and 0.8 bar for the atomizing air. Resin powder was deposited in the web at a weight of 250 g/m². The infra-red heater was omitted and the powdered web was heated in the electric oven only, at a temperature of 170° C. for 2 min., using a low speed setting for the recirculating air.

Corundum particles were then applied to the bonded web in the following manner. An abrasive-resin slurry was prepared by mixing together thoroughly the particles (25%) and the phenolic resin (75%). The slurry was then transferred to the supply tank of the spray booth having four spray guns. The bonded web was passed through the spray booth at a speed of 2 m/min, and sprayed on one side with the slurry from the guns to provide even coverage of the web with the slurry at a coating weight of about 230-260 g/m². The web was then passed through the gas oven in which it was heated at 180° C. for 2 min. to cure the phenolic resin. The web was then turned over and conveyed again through the spray booth so that it was sprayed with slurry on the other side in the same manner. It was then again passed through the gas oven to yield a nonwoven scouring web which was cut into domestic scouring pads.

Results

Samples of the domestic scouring pads resulting from Examples 1 and 2 were used for cleaning soiled dishes in a simulated domestic environment and, based on a visual assessment, were found to offer a performance comparable to that of conventional synthetic scouring pads and, generally, better than that of traditional scouring pads made from natural fibres.

An advantage of the processes described in Examples 1 and 2 is that no volatile organic compounds (VOCs) are produced in the formation of the pre-bonded webs 21. In addition, the energy required in these processes to produce the pre-bonded webs may be less than that required if a liquid pre-bond resin were used. Consequently, the environmental effects of the processes can be substantially less than those conventionally used to produce synthetic scouring materials.

The scouring pads produced by the processes of Examples 1 and 2 offer the advantage that they can more easily be recycled after use since they are formed using natural vegetable fibres. Despite that, the homogeneity of the scouring pads is high compared with traditional natural fibre scourers making it possible to offer, to the consumer, an environmentally-friendly but comparatively standardized product. In addition, the scouring pads exhibit the advantageous openness of both traditional natural fibre scourers and conventional synthetic scourers, together with the abrasive performance of the latter. These advantages are considered to be a consequence of the fact that the scouring pads comprise a mechanically-formed (dry-laid) web of natural fibres which is pre-bonded in a way that does not involve the web being subjected to pressure (e.g. as a result of contact by rollers) that could irreversibly compress or damage the web fibres.

It will be appreciated that, although the above Examples describe the manufacture of domestic scouring pads, other scouring materials and articles could be produced in a similar way with appropriate changes where necessary in the materials and process steps employed.

1-20. (canceled)

21. A scouring material comprising:
a three-dimensional non-woven web of entangled fibres bonded to one another at their mutual contact points by a pre-bond resin, wherein a majority by weight of the fibres comprise natural fibres, and the bonded web has a maximum density of 50 kg/m³; and
a plurality of abrasive particles adhered to the fibres of the bonded web by a make-coat resin.

22. The scouring material of claim 21, wherein the bonded web has a maximum density of 30 kg/m³.

23. The scouring material of claim 21, wherein the bonded web has a minimum thickness of 5 mm.

24. The scouring material of claim 21, wherein at least 80% by weight of the fibres comprise natural fibres.

25. The scouring material of claim 21, wherein all of the fibres comprise natural fibres.

26. The scouring material of claim 21, wherein the natural fibres are natural vegetable fibres.

27. The scouring material of claim 21, wherein the natural fibres comprise coco, sisal, or hemp fibres, or a combination thereof.

28. The scouring material of claim 21, wherein the pre-bond resin is a thermosetting or a thermoplastic resin.

29. The scouring material of claim 21, wherein the pre-bond resin is an epoxy resin or a co-polyamide resin.

30. A The scouring material of claim 21, wherein the make-coat resin is a latex or a phenolic resin.

31. The scouring material of claim 21, wherein the abrasive particles comprise an inorganic material and have an average particle size of about 50 microns.

32. The scouring material of claim 21, wherein the abrasive particles comprise a polymeric material or a natural material.

33. The scouring material of claim 21, wherein the non-woven web is a dry-laid web.

34. The scouring material of claim 21, wherein the scouring material forms a hand-held scouring pad.

35. A method of making a scouring material, comprising:
(i) forming a three-dimensional nonwoven web of natural fibres contacted with dry particulate material that includes fusible binder particles;
(ii) exposing the web to conditions that cause the binder particles to form a flowable liquid binder;
(iii) solidifying the liquid binder to form bonds between the fibres of the web and thereby provide a pre-bonded web; and
(iii) applying abrasive particles to the pre-bonded web, and
(iv) bonding the abrasive particles to the fibres of the pre-bonded web by at least a make-coat resin to provide the scouring material.

36. The method of claim 35, wherein the binder particles are applied to the web without applying a compressive force to the web.

37. The method of claim 35, further comprising:
depositing the abrasive particles across the whole thickness of the web under the action of an electrostatic force.

38. The method of claim 35, further comprising:
applying an electrostatic charge to the binder particles, which are then directed towards the web while the web is located in an electrically-grounded support surface.

39. The method of claim 15, wherein the abrasive particles and the make-coat resin are applied to the pre-bonded web together as a slurry.

40. The method of claim 15, wherein the slurry is sprayed onto the pre-bonded web.
